(19) United States
(12) Patent Application Publication
(10) Pub. No.: US 2022/0339646 A1
(43) Pub. Date: Oct. 27, 2022

(54) ELECTROSTATIC SPRAY DEVICE

(71) Applicant: YANTAI JEREH PRETROLEUM EQUIPMENT & TECHNOLOGIES CO., LTD., Yantai, Shandong (CN)

(72) Inventors: Mingming YU, Yantai (CN); Yushuai GE, Yantai (CN); Fengwen LIU, Yantai (CN); Qingfeng YU, Yantai (CN)

(73) Assignee: YANTAI JEREH PRETROLEUM EQUIPMENT & TECHNOLOGIES CO., LTD., Yantai, Shandong (CN)

(21) Appl. No.: 17/422,126

(22) PCT Filed: Apr. 19, 2021
(86) PCT No.: PCT/CN2021/088099

§ 371 Date: Jul. 9, 2021

(30) Foreign Application Priority Data
Oct. 16, 2020 (CN) 202022306902.1

(51) Int. Cl. B05B 5/03; B05B 5/16; B05B 5/053

(52) U.S. Cl. CPC B05B 5/03; B05B 5/1691; B05B 5/0533

(57) ABSTRACT

An electrostatic spray device, including: a housing, a tubular member, a nozzle and an airflow providing member. In a first direction from a second end portion to a first end portion of the housing, a second opening of the tubular member is located at a side of a first opening of the housing away from the second end portion. The nozzle is at least partially located in a second accommodating space defined by the tubular member. The nozzle is configured to spray mist towards the second opening through a spray opening, and the mist leaves the electrostatic spray device from the second opening in a charged state. The airflow providing member is configured to provide airflow towards the first opening and the second opening.

### CROSS-REFERENCE TO RELATED APPLICATION

For all purposes, the present application claims priority of the Chinese patent application No. 202022306902.1, filed on Oct. 16, 2020, the entire disclosure of which is incorporated herein by reference as part of the present application.

### TECHNICAL FIELD

Embodiments of the present disclosure relate to an electrostatic spray device.

### BACKGROUND

With the outbreak of epidemics diseases, infectious diseases and the like, people's awareness of daily disinfection has generally increased. Spraying chemical reagents is the most common and efficient epidemic prevention method. However, an existing conventional spray product is sprayed to a surface of a target object which is only located directly in front of a nozzle and the scope of operation is limited, which adversely affects the disinfection effect and work efficiency. The electrostatic spray technology greatly improves the adsorption effect of droplets on the target object, thereby increasing the utilization efficiency of the liquid medicine and saving the cost.

### SUMMARY

An embodiment of the present disclosure provides an electrostatic spray device, including: a housing, a tubular member, a nozzle, and an airflow providing member. The housing defines a first accommodating space and has a first end portion and a second end portion opposite to each other; a first opening is provided at a position of the first end portion farthest away from the second end portion in a first direction from the second end portion to the first end portion. The tubular member defines a second accommodating space and has a third end portion that is away from the second end portion in the first direction and a fourth end portion that is close to the second end portion in the first direction; a second opening is provided at a position of the third end portion farthest away from the fourth end portion in the first direction, and the second opening is located on a side of the first opening away from the second end portion in the first direction. The nozzle is at least partially located in the second accommodation space; the nozzle includes a spray opening at a position farthest away from the second end portion in the first direction; the spray opening is located on a side of the second opening facing towards the fourth end portion in the first direction; the nozzle is configured to spray mist towards the second opening through the spray opening, and the mist leaves the electrostatic spray device from the second opening in a charged state. The airflow providing member is configured to provide an airflow which is ejected through the first opening and the second opening to leave the electrostatic spray device.

In an example, at least part of the first inner surface of the first end portion facing towards the first accommodating space encloses a first region on a reference plane perpendicular to the first direction, and an area of the first region gradually decreases as the reference plane moves along the first direction.

In an example, at least part of the first outer surface of the tubular member facing away from the second accommodating space encloses a second region on the reference plane, and an area of the second region gradually decreases as the reference plane moves along the first direction; and the at least part of the first outer surface includes a surface portion not overlapped with the tubular member in a second direction perpendicularly intersecting the first direction.

In an example, the electrostatic spray device further including a guide member connected to the nozzle, at least part of the guide member is on a side of the fourth end portion of the tubular member away from the third end portion and is located outside the second accommodating space.

In an example, the tubular member is partially located in the first accommodating space, and the first inner surface of the first end portion and the first outer surface of the tubular member facing away from the second accommodating space define a first gas channel; the second inner surface of the tubular member facing towards the second accommodation space and a guide surface of at least one selected from a group consisting of the guide member and the nozzle facing towards at least one selected from a group consisting of the tubular member and the housing define a second gas channel, the first gas channel and the second gas channel intercept a first annular region and a second annular region on the reference plane respectively, and a ratio of an area of the second annular region to an area of a first annular region is ranged from 0.2 to 5.

In an example, the guide member has a second outer surface exposed to at least one selected from a group consisting of the first accommodating space and the second accommodating space; in the first direction, the airflow providing member is located on the side of the fourth end portion of the tubular member away from the third end portion, at least part of the nozzle is located on a side of the guide member away from the airflow providing member, the at least part of the nozzle has a third outer surface exposed to at least one selected from a group consisting of the first accommodating space and the second accommodating space, and the guide surface includes the third outer surface and the second outer surface; at least part of the second outer surface encloses a third region on the reference plane, at least part of the third outer surface encloses a fourth region on the reference plane, an area of at least one selected from a group consisting of the third region and the fourth region gradually decreases as the reference plane moves along the first direction.

In an example, in the first direction, the second opening of the tubular member is positionally adjustable relative to at least one selected from a group consisting of the first opening of the housing and the spray opening of the nozzle.

In an example, the housing and the tubular member are slidably connected to each other.

In an example, in the first direction, a distance between the second opening and the first opening is ranged from 5 mm to 120 mm.

In an example, the electrostatic spray device further includes an annular electrode connected to the third end portion of the tubular member, wherein in the first direction, at least part of the annular electrode is farther away from the fourth end portion of the tubular member than the spray opening, and a distance between the at least part of the annular electrode and the spray opening is ranged from 11 mm to 30 mm.

In an example, the tubular member includes a tubular body part and an annular pressing element, the annular electrode is at least partially located in an annular groove of the tubular body part, and the annular pressing element is connected to the tubular body part and is configured to limit a position of the annular electrode in the first direction.

In an example, the second accommodation space is in communication with the annular groove.

In an example, the tubular body part includes a first portion located between the annular groove and the second inner surface in a second direction perpendicularly intersecting the first direction and a second portion located between the annular groove and the first outer surface in the second direction; the annular pressing element includes a first pressing element body part in an annular shape, the first pressing element body part is buckled to the second portion of the tubular body part, and the first pressing element body part is spaced apart from the annular electrode in the first direction.

In an example, the annular pressing element further includes a plurality of first protrusions, the plurality of first protrusions are arranged at intervals on a surface of the first pressing element body part facing towards the annular electrode and abut against at least one selected from a group consisting of the first portion of the tubular body part and the annular electrode, each of the plurality of first protrusions has a thickness greater than 0 and less than or equal to 5 mm in the first direction.

In an example, the electrostatic spray device further includes a strip-shaped electrode connected to the annular electrode, wherein the tubular member further includes a strip-shaped pressing element connected to the tubular body part, a strip-shaped groove is provided on an inner side of the tubular body part, and the strip-shaped pressing element is at least partially located in the strip-shaped groove and limits a portion of the strip-shaped electrode between the tubular body part and the strip-shaped pressing element, another portion of the strip-shaped electrode is located on a side of the tubular member away from the second opening and is located outside the tubular member.

In an example, the annular pressing element further includes a second protrusion on a surface of the first pressing element body part facing towards the annular electrode, the strip-shaped pressing element includes a strip-shaped second pressing element body part and at least one first fin located on the second pressing element body part; the second protrusion presses against the at least one first fin in the strip-shaped groove and is located on a side of the at least one first fin facing towards the second accommodating space.

In an example, the strip-shaped pressing element further includes at least one second fin, and the at least one second fin is located at an end of the second pressing element body part away from the at least one first fin, and the strip-shaped pressing element is engaged into the strip-shaped groove of the tubular member through the at least one second fin.

In an example, the electrostatic spray device further includes a liquid pump and a first connecting pipe, wherein the liquid pump is located between the nozzle and the airflow providing member in the first direction, and the first connecting pipe communicates the nozzle with the liquid pump.

In an example, the electrostatic spray device further includes a second connecting tube and a liquid storage bottle, wherein the liquid storage bottle includes a bottle body and a bottle cap, and at least one selected from a group consisting of the bottle body and the bottle cap is detachable connected to the housing, and the second connecting pipe fluidly communicates the liquid storage bottle to the liquid pump.

In an example, two opposite ends of the guide member are connected to the nozzle and the liquid pump, respectively.

In an example, the electrostatic spray device further includes an electrostatic generating module located between the liquid pump and the airflow providing member in the first direction, wherein the electrostatic generation module is configured to provide a constant voltage to the annular electrode; at least two selected from a group consisting of the nozzle, the liquid pump, the electrostatic generation module, and the airflow providing member are coaxially arranged, and the airflow providing member is an axial flow fan.

In an example, the nozzle, the tubular member, the first end portion of the housing, and the airflow providing member are coaxially arranged.

In an example, the electrostatic spray device further includes a holding part and a battery module which are connected to the second end portion of the housing, wherein the housing and the battery module are located at two opposite ends of the holding part, the holding part is provided with a switching element, and the battery module is configured to provide power supply for at least one selected from a group consisting of the liquid pump, the electrostatic generating module and the airflow providing member under control of the switching element.

In an example, the electrostatic spray device further includes an annular mesh member located between the housing and the guide member in a second direction perpendicularly intersecting the first direction, wherein the annular mesh member is located on the side of the fourth end portion of the tubular member away from the third end portion in the first direction.

In an example, the electrostatic spray device further includes a light emitting element mounted at the fourth end portion of the tubular member.

### BRIEF DESCRIPTION OF THE DRAWINGS

In order to explain the embodiments of the present disclosure or the technical solutions in the prior art more clearly, the drawings used in the embodiments or the description of the prior art will be briefly introduced below. Obviously, the drawings in the following description are only some embodiments of this disclosure, and other embodiments can be obtained by those ordinarily skilled in the art according to these drawings without inventive work.

FIG. 1 is a schematic structural diagram of an electrostatic spray device provided by an embodiment of the present disclosure;

FIG. 2 is a schematic diagram of a nozzle, a guide member and a liquid pump of the electrostatic spray device which are connected to form an integral structure provided by an embodiment of the present disclosure;

FIGS. 3A and 3B are three-dimensionally schematic diagrams of a tubular member in an electrostatic spray device provided by an embodiment of the present disclosure;

FIG. 4A is a partially exploded schematic diagram of a tubular member in an electrostatic spray device provided by an embodiment of the present disclosure;

FIG. 4B is a three-dimensionally structural diagram of an electrode assembly in an electrostatic spray device provided by an embodiment of the present disclosure;

FIG. 4C is a three-dimensionally structural diagram of an annular pressing element in an electrostatic spray device provided by an embodiment of the present disclosure;

FIG. 4D a three-dimensionally structural diagram of a strip-shaped pressing element in an electrostatic spray device provided by an embodiment of the present disclosure;

FIG. 5A is a schematically structural diagram of a cross-section of a tubular member in an electrostatic spray device provided by an embodiment of the present disclosure wherein an annular pressing element is separated from a tubular body part;

FIG. 5B is an enlarged schematic view of the dashed box part of the cross-sectional structure of the tubular member in the electrostatic spray device shown in FIG. 5A, wherein the annular pressing element is mounted onto the tubular body part.

### DETAILED DESCRIPTION

In order to make objects, technical details and advantages of the embodiments of the present disclosure apparent, the technical solutions of the embodiment will be described in a clearly and fully understandable way in connection with the drawings related to the embodiments of the present disclosure. It is obvious that the described embodiments are just a part but not all of the embodiments of the present disclosure. Based on the described embodiments herein, those skilled in the art can obtain other embodiment(s), without any inventive work, which should be within the scope of the present disclosure.

Unless otherwise specified, the technical terms or scientific terms used in the present disclosure should be of general meaning as understood by those ordinarily skilled in the art. In the disclosure, words such as “first”, “second” and the like do not denote any order, quantity, or importance, but rather are used for distinguishing different components. Similarly, words such as “include” or “comprise” and the like denote that elements or objects appearing before the words of “include” or “comprise” cover the elements or the objects enumerated after the words of “include” or “comprise” or equivalents thereof, not exclusive of other elements or objects. Words such as “connected” or “connecting” and the like are not limited to physical or mechanical connections, but may include electrical connection, either direct or indirect. Words such as “up”, “down”, “left”, “right” and the like are only used for expressing relative positional relationship, when the absolute position of the described object is changed, the relative positional relationship may also be correspondingly changed.

At present, the electrostatic spray technology is mainly used in the agricultural field and is generally embodied as a large-scale apparatus, which cannot meet the daily use at indoors environment. If the electrostatic spray technology is used indoors, charged mist are deposited in a direction opposite to the spray direction along an electric field line under the action of the electric field force and absorbed on the operator's body, thus affecting the user experience; in addition, if the operation time is long, the mist sucked back onto the spray apparatus continue to accumulate to form water droplets containing drugs; such water droplets fall on the ground, they will cause pollution and even cause more serious hazard such as fire in the case that they fall on an electrical apparatus.

Embodiments of the present disclosure provides an electrostatic spray device, including: a housing, a tubular member, a nozzle, and an airflow providing member. The housing defines a first accommodating space and has a first end portion and a second end portion opposite to each other; a first opening is provided at a position of the first end portion farthest away from the second end portion in a first direction from the second end portion to the first end portion. The tubular member defines a second accommodating space and has a third end portion that is away from the second end portion in the first direction and a fourth end portion that is close to the second end portion in the first direction; a second opening is provided at a position of the third end portion farthest away from the fourth end portion in the first direction, and the second opening is located on a side of the first opening away from the second end portion in the first direction. The nozzle is at least partially located in the second accommodation space; the nozzle comprises a spray opening at a position farthest away from the second end portion in the first direction; the spray opening is located on a side of the second opening facing towards the fourth end portion in the first direction, the nozzle is configured to spray mist towards the second opening through the spray opening, and the mist leaves the electrostatic spray device from the second opening in a charged state. The airflow providing member is configured to provide an airflow which is ejected through the first opening and the second opening to leave the electrostatic spray device.

In this way, the charged mist ejected from the second opening is effectively prevented from being sucked back onto the electrostatic spray device.

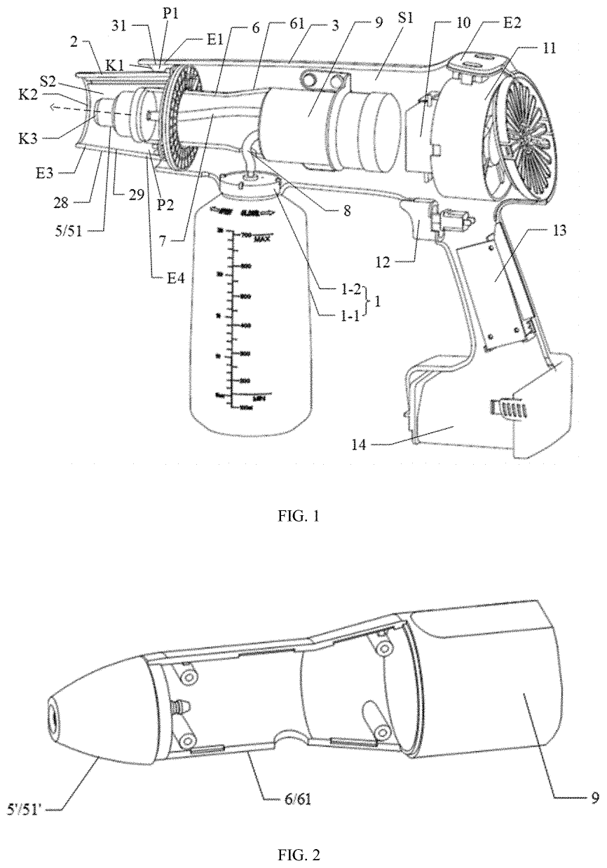

FIG. 1 is a schematically structural diagram of an electrostatic spray device provided by an embodiment of the present disclosure.

Referring to FIG. 1, the electrostatic spray device provided by the embodiment of the present disclosure includes: a housing 3, a tubular member 2, a nozzle 5 and an airflow providing member 11.

The housing 3 defines a first accommodating space S1. The housing 3 has a first end portion E1 and a second end portion E2 opposite to each other.

In a first direction from the second end portion E2 to the first end portion E1, the first end portion E1 has a first opening K1 at a position farthest away from the second end portion E2.

The tubular member 2 defines a second accommodating space S2. The tubular member 2 has a third end portion E3 away from the second end portion E2 and a fourth end portion E4 close to the second end portion E2 in the first direction. The third end portion E3 and the fourth end portion E4 of the tubular member 2 are opposite to each other in the first direction.

For example, the tubular member 2 is partially located in the first accommodation space S1.

In another example, the tubular member 2 can be completely located outside the first accommodating space S1. That is, in a second direction perpendicularly intersecting the first direction, the tubular member 2 is not overlapped with the housing 3.

In the first direction, the third end portion E3 of the tubular member 2 has a second opening K2 at a position farthest away from the fourth end portion E4. The second opening K2 is located on a side of the first opening K1 away from the second end portion E2 in the first direction.

For example, both the tubular member 2 and the housing 3 are made by insulation materials. The specific materials of the tubular member 2 and the housing 3 are not limited herein. For example, in another example, the tubular member 2 and the housing 3 can be made by non-insulation materials.

The nozzle 5 is at least partially located in the second accommodating space S2. The nozzle 5 includes a spray opening K3 at a position farthest away from the second end portion E2 in the first direction, and the spray opening K3 is located on a side of the second opening K2 facing towards the fourth end portion E4 in the first direction.

The nozzle 5 is configured to spray mist towards the second opening K2 through the spray opening K3, and the mist in a charged state leaves the electrostatic spray device from the second opening K2.

In the embodiment, for example, the nozzle 5 does not include an electrode, and the mist sprayed from the spray opening K3 is not substantially charged. The mist is electrostatically induced to be substantially in the charged state and then leave the electrostatic spray device from the second opening K2, when it moves through an annular electrode 41 (which will be described at below) in the vicinity of the second opening K2 of the tubular member 2. That is, in this situation, the mist is not in a charged state at the spray opening K3, while it is in the charged state at the second opening K2.

In another embodiment, for example, the nozzle 5 includes an electrode so that the charged mist are sprayed from the spray opening K3 and then further leave the electrostatic spray device from the second opening K2 of the tubular member 2. That is, in this situation, the mist are in the charged state at both the spray opening K3 and the second opening K2.

Herein, it is not limited to whether the nozzle 5 itself contains an electrode or not (that is, it is not limited to whether the mist sprayed from the nozzle 5 through the spray opening K3 are charged or not), as long as the mist sprayed from the second opening K2 is in a charged state.

For example, the direction of a central axis of the nozzle 5 is an axial direction. The first direction is the axial direction of the nozzle 5. In FIG. 1, the first direction is schematically shown by the dotted arrow.

The airflow providing member 11 is configured to provide airflow towards the first opening K1 and the second opening K2.

For example, in the first direction, the airflow providing member 11 is located on the side of the fourth end portion E4 of the tubular member 2 away from the third end portion E3.

In the embodiment shown in FIG. 1, the nozzle 5 is completely located in the second accommodation space S2. However, the embodiment of the present disclosure is not limited thereto. In another example, a portion of the nozzle can be on a side of the fourth end portion E4 of the tubular member 2 away from the third end portion E3 in the first direction and be outside the second accommodating space S2 of the tubular member 2.

In this way, at least part of the airflow from the airflow providing member 11 is ejected along the first outer surface 28 of the tubular member 2 to effectively blow the charged mist that may possibly be sucked back onto the first outer surface 28 of the tubular member 2, thereby effectively reducing the charged mist sucked back onto the first outer surface 28 of the tubular member 2.

The first end portion E1 of the housing 3 overlaps the tubular member 2 in the second direction perpendicularly intersecting the first direction. Herein, in the case that the first direction coincides with the central axis of the nozzle 5, the second direction corresponds to a radial direction perpendicularly intersecting the central axis.

At least part of the first inner surface 31 of the first end portion E1 facing towards the first accommodating space S1 encloses a first region on a reference plane perpendicular to the first direction, and an area of the first region decreases gradually as the reference plane moves along the first direction.

Herein, the reference plane perpendicular to the first direction is a virtual plane. The first region enclosed by the at least part of the first inner surface 31 on the reference plane means that: the at least part of the first inner surface 31 intersects the reference plane and the first region enclosed on the reference plane has a substantially closed shape. The size of the area of the first region represents the size of the corresponding portion of the first accommodating space at a position of the reference plane. The area of the first area decreasing gradually as the reference plane moves along the first direction can indicate that the corresponding portion of the first accommodating space gradually decreases in the first direction.

For example, the first inner surface 31 has a streamlined shape as a whole.

For example, the region enclosed by the at least part of the first inner surface 31 on the reference plane is substantially a circular region. The specific shape of the region enclosed by the at least part of the first inner surface 31 on the reference plane is not limited herein.

Due to the above-mentioned shape characteristics of the first inner surface 31, the wind pressure of the airflow ejected along the first outer surface 28 of the tubular member 2 can be enhanced, which is more beneficial to reduce the charged mist sucked back onto the first outer surface 28 of the tubular member 2.

For example, at least part of the first outer surface 28 of the tubular member 2 facing away from the second accommodating space S2 encloses a second region on the reference plane, and an area of the second region gradually decreases as the reference plane moves along the first direction. The at least part of the first outer surface 28 includes a surface portion not overlapped with the tubular member 2 in the second direction.

For example, the region enclosed by the at least part of the first outer surface 28 on the reference plane is substantially a circular area. The specific shape of the region enclosed by the at least part of the first outer surface 28 on the reference plane is not limited herein.

In the embodiment shown in FIG. 1, the area of the second region enclosed by the entire first outer surfaces 28 of the tubular member 2 facing away from the second accommodating space S2 on the reference plane gradually decreases as the reference plane moves in the first direction. That is, the first outer surface 28 of the tubular member 2 has a streamlined shape as a whole, so that the airflow flows more smoothly.

In this way, it is further beneficial to reduce the charged mist sucked back onto the first outer surface 28 of the tubular member 2.

The specific shape of the first outer surface 28 of the tubular member 2 is not limited herein. In another example, the tubular member 2 can be a straight tube, and the first outer surface 28 of the tubular member 2 is in a shape of cylindrical side surface.

With continued reference to FIG. 1, for example, the electrostatic spray device provided by the embodiment of the present disclosure further includes a guide member 6 connected to the nozzle 5. For example, a portion of the guide member 6 is located in the second accommodation space S2. The portion of the guide member 6 overlaps the tubular member 2 in the second direction. Another portion of the guide member 6 is on the side of the fourth end portion E4 of the tubular member 2 away from the third end portion E3 and is located outside the second accommodation space S2; the another portion of the guide member 6 does not overlap the tubular member 2 in the second direction.

For example, the guide member 6 is made by an insulation material. The specific material of the guide member 6 is not limited herein. For example, in another example, the guide member 6 can be made by a non-insulation material.

It is understood that the embodiments of the present disclosure do not limit whether the guide member 6 is partially located in the second accommodating space S2 or not; that is, in the second direction, the guide member 6 may overlap the tubular member 2 or not. In another example, the nozzle 5 has a sufficient length in the first direction, and a portion of the nozzle 5 and the entire guide member 6 are located on the side of the fourth end portion E4 of the tubular member 2 away from the third end portion E3 and are outside the second accommodating space S2. The portion of the nozzle 5 and the entire guide member 6 are located in the first accommodating space S1.

For example, in the embodiment, the guide member 6 is detachably connected to the nozzle 5. However, the embodiment of the present disclosure does not limit the connection manner of the nozzle 5 and the guide member 6.

In another example, at least part of the nozzle 5 and the guide member 6 are formed as a single non-detachable entirety.

For example, the first inner surface 31 of the first end portion E1 of the housing 3 and the first outer surface 28 of the tubular member 2 facing away from the second accommodating space S2 define a first gas channel P1. That is, the first gas channel P1 is bounded by the first inner surface 31 of the first end portion E1 of the housing 3 and the first outer surface 28 of the tubular member 2 facing away from the second accommodating space S2.

For example, a second inner surface 29 of the tubular member 2 facing towards the second accommodating space and a guiding surface of at least one selected from a group consisting of the guide member 6 and the nozzle 5 facing towards at least one selected from a group consisting of the tubular member 2 and the housing 3 define a second gas channel P2. That is, the second gas channel P2 is bounded by the second inner surface 29 of the tubular member 2 facing towards the second accommodating space and the guide surface of at least one selected from a group consisting of the guide member 6 and the nozzle 5 facing towards the at least one selected from a group consisting of the tubular member 2 and the housing 3.

For example, referring to FIG. 1, the guide member 6 has a second outer surface 61 exposed to at least one selected from a group consisting of the first accommodating space S1 and the second accommodating space S2. In the first direction, at least part of the nozzle 5 is located on a side of the guide member 6 away from the airflow providing member 11, and the at least part of the nozzle 5 has a third outer surface 51 exposed to the second accommodating space S2. For example, the guide surface of the at least one selected from a group consisting of the guide member 6 and the nozzle 5 facing towards the at least one selected from a group consisting of the tubular member 2 and the housing 3 includes the second outer surface 61 and the third outer surface 51. The embodiments of the present disclosure are not limited thereto.

In another example, the guide member 6 is partially located in the second accommodating space S2, and the surface of the nozzle 5 facing towards the at least one selected from a group consisting of the tubular member 2 and the housing 3 is completely covered by the guide member 6, so that the surface of the nozzle 5 facing towards the at least one selected from a group consisting of the tubular member 2 and the housing 3 is not exposed to any one of the first accommodating space S1 and the second accommodating space S2. In this situation, the guide surface of the at least one selected from a group consisting of the guide member 6 and the nozzle 5 facing towards the at least one selected from a group consisting of the tubular member 2 and the housing 3 for example includes only the second outer surface 61 of the guide member 6 exposed to the first accommodation space S1 and the second accommodation space S2.

In another example, the guide member 6 and the tubular member 2 do not overlap each other in the second direction, and the third outer surface 51 of the nozzle 5 is exposed to the first accommodating space S1 and the second accommodating space S2. Because an end of the guide member 6 away from the nozzle 5 in the first direction is closer to the airflow providing member 11 than the fourth end portion of the tubular member 2, the airflow from the airflow providing member 11, before entering the first gas channel P1 and the second gas channel P2, is first guided in between the second outer surface 61 of the guide member 6 and the inner surface of the housing 3 facing towards the second containing space, by the end of the guide member 6 away from the nozzle 5. This is beneficial for the airflow from the airflow providing member 11 to be smoothly distributed in the first gas channel P1 and the second gas channel P2.

The airflow from the airflow providing member 11 passes through the second air passage P2 and is ejected from the electrostatic spray device through the second opening K2, so that the spray distance of the mist from the second opening K2 is increased. When the airflow flows along the first outer surface 28 of the tubular member 2, the mist sucked back onto the first outer surface 28 of the tubular member 2 is air conveyed again, so as to prevent the mist from accumulating on the first outer surface 28 to form water droplets.

For example, the second gas channel P2 and the first gas channel P1 intercept a first annular region and a second annular region on the reference plane respectively, and the ratio of the area of the second annular region to the area of the first annular region is ranged from 0.2 to 5.

In this way, under the action of the second gas channel P2 and the first gas channel P1, good air-conveying effect and good anti-sucked back effect are achieved.

For example, in the first direction, the distance between the second opening K2 and the first opening K1 is ranged from 5 mm to 120 mm.

In this way, the good spray effect and the good anti-absorption effect are guaranteed at the same time.

For example, at least part of the second outer surface 61 encloses a third region on the reference plane, at least part of the third outer surface 51 encloses a fourth region on the reference plane, and an area of at least one selected from a group consisting of the third region and the fourth region gradually decreases as the reference plane moves along the first direction.

For example, referring to FIG. 1, a portion of the second outer surface 61 of the guide member 6 is in a shape of cylindrical side surface. Another portion of the second outer surface 61 of the guide member 6 is in a shape of truncated cone side surface. That is, the area of the third region enclosed by the another portion of the second outer surface 61 of the guide member 6 on the reference plane gradually decreases as the reference plane moves in the first direction.

For example, the second outer surface 61 of the guide member 6 has a streamlined shape. However, the specific shape of the second outer surface 61 of the guide member 6 is not limited in the embodiment of the present disclosure.

For example, referring to FIG. 1, the first surface portion of the third outer surface 51 of the nozzle 5 exposed to the second accommodating space S2 has the shape of cylindrical side surface with a smaller radius, the second surface portion of the third outer surface 51 has the shape of cylindrical side surface with a larger radius, and the third surface portion of the third outer surface 51 is located between the second surface portion and the first surface portion and has the shape of truncated cone side surface. That is, the area of the fourth region enclosed by the third surface portion of the third outer surface 51 on the reference plane gradually decreases as the reference plane moves in the first direction.

For example, the third outer surface 51 of the nozzle 5 is has a streamlined shape. However, the specific shape of the third outer surface 51 of the nozzle 5 is not limited in the embodiment of the present disclosure.

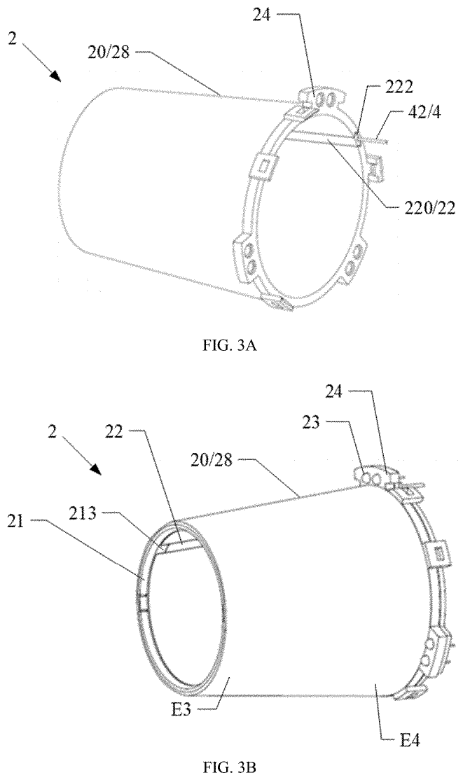

FIG. 2 is a schematic diagram of a nozzle, a guide member and a liquid pump of the electrostatic spray device which are connected to form an integral structure provided by an embodiment of the present disclosure.

Referring to FIG. 2, in another example, the area of the fourth region enclosed by the entire third outer surface 51′ of the nozzle 5′ on the reference plane gradually decreases as the reference plane moves in the first direction.

For example, the maximum area of the fourth region is less than or equal to the minimum area of the third region.

In the first direction, the guide member 6 is located between the nozzle 5 and the liquid pump 9. Two opposite ends of the guide member 6 are respectively connected to the nozzle 5 and the liquid pump 9 so that the guide member 6, the nozzle 5 and the liquid pump 9 are connected to form an integral structure. In this way, the guide member 6, the nozzle 5, and the liquid pump 9 can be connected to the housing 3 through a same positioning member, so that the integral structure of the guide member 6, the nozzle 5 and the liquid pump 9 is positioned in the first accommodating space S1 and the second accommodating space S2. Compared to the case that the guide member 6, the nozzle 5, and the liquid pump 9 are respectively connected to the housing 3 or the tubular member 2 by using different positioning members so as to be positioned in the first accommodating space S1 and the second accommodating space S2, the number of connection members are reduced, and in turns the wind resistance are reduced.

For example, the nozzle 5 and the guide member 6 are quickly connected to each other by buckle or thread.

Optionally, in the first direction, the second opening K2 of the tubular member 2 is positionally adjustable relative to at least one selected from a group consisting of the first opening K1 of the housing 3 and the spray opening K3 of the nozzle 5.

For example, the housing 3 and the tubular member 2 are slidably connected to each other. For example, at least one sliding groove extending in the first direction is provided on the inner surface of the housing 3; at least one protruding structure is provided on the outer surface of the tubular member 2; and the at least one sliding groove and the at least one protruding structure cooperate with each other so that the tubular member is allowed to slide in the first direction relative to the housing 3.

The distance between the second opening K2 of the tubular member 2 and the first opening K1 of the housing 3 in the first direction is a first distance; the distance between the second opening K2 of the tubular member 2 and the spray opening K3 of the nozzle 5 in the first direction is a second distance. By adjusting the magnitude of the first distance and the second distance, it is possible to adjust and optimize the balance among the charge of the mist, the spray distance and the anti-sucked back effect according to the requirements.

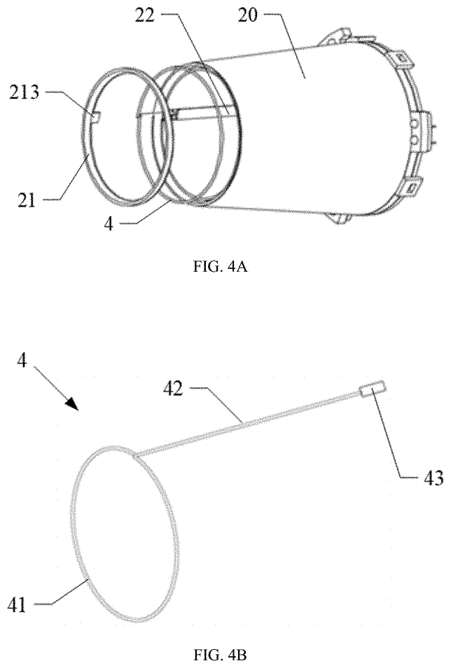

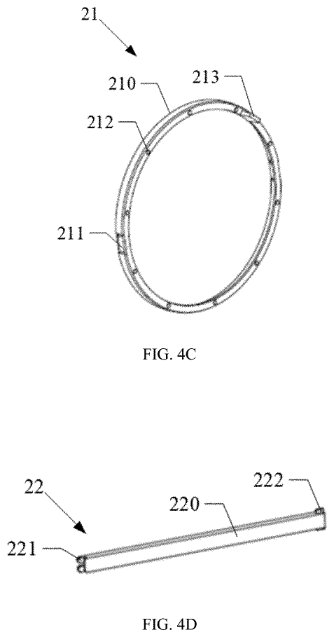

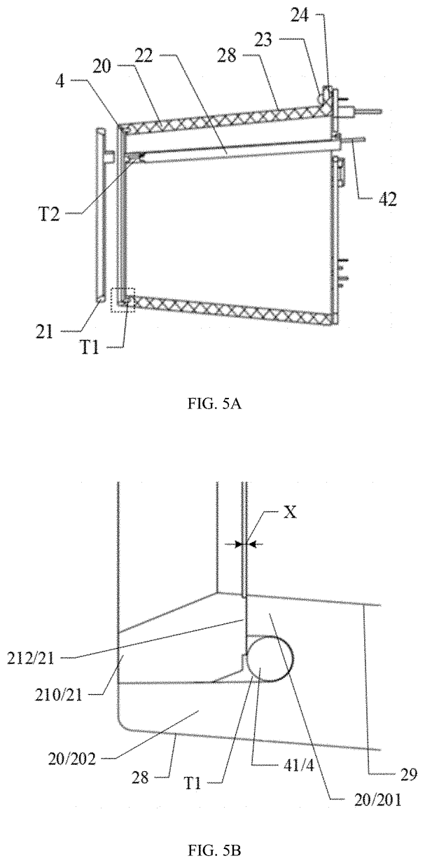

FIGS. 3A and 3B are three-dimensionally schematic diagrams of a tubular member in an electrostatic spray device provided by an embodiment of the present disclosure; FIG. 4A is a partially exploded schematic diagram of a tubular member in an electrostatic spray device provided by an embodiment of the present disclosure; FIG. 4B is a three-dimensionally structural diagram of an electrode assembly in an electrostatic spray device provided by an embodiment of the present disclosure; FIG. 4C is a three-dimensionally structural diagram of an annular pressing element in an electrostatic spray device provided by an embodiment of the present disclosure; FIG. 4D is a three-dimensionally structural diagram of a strip-shaped pressing element in an electrostatic spray device provided by an embodiment of the present disclosure; FIG. 5A is a schematically structural diagram of a cross-section of a tubular member in an electrostatic spray device provided by an embodiment of the present disclosure wherein an annular pressing element is separated from a tubular body part; and FIG. 5B is an enlarged schematic view of the dashed box part of the cross-sectional structure of the tubular member in the electrostatic spray device shown in FIG. 5A, wherein the annular pressing element is mounted onto the tubular body part.

Referring to FIGS. 3A to 5B, for example, the electrostatic spray device provided by the embodiment of the present disclosure further includes an electrode assembly 4 partially embedded and mounted in the tubular member 2. In this way, not only the mist is well charged, but also the safety is ensured.

The electrode assembly 4 includes an annular electrode 41 and a strip-shaped electrode 42 which are connected to each other.

The annular electrode 41 is configured to charge the spray sprayed from the nozzle 5 due to electrostatic induction; the strip-shaped electrode 42 is configured to electrically connect to both the annular electrode 41 and an electrostatic generation module to be described as below.

For example, the annular electrode 41 is embedded and mounted in the third end portion E3 of the tubular member 2.

For example, the annular electrode 41 has a circular annular shape and is arranged coaxially with the nozzle 5. The embodiment of the present disclosure does not limit the specific shape of the annular electrode 41.

Referring to FIGS. 1, 5A and 5B, for example, in the first direction, at least part of the annular electrode 41 is farther away from the fourth end portion E4 of the tubular member 2 than the spray opening K3, and the distance between the at least part of the annular electrode 41 and the spray openings K3 is ranged from 11 mm to 30 mm.

It is understood that, referring to FIGS. 5A and 5B, the annular electrode 41 in the embodiment for example has a circular shape in a cross section where the central axis of the tubular member 2 is located. However, the embodiments of the present disclosure are not limited thereto.

In another example, for example, the annular electrode 41 has a longer length in the first direction; that is, in the cross section where the central axis of the tubular member 2 is located, the annular electrode 41 has a strip shape extending in the first direction.

For example, in the case that the annular electrode 41 has the longer length in the first direction, at least part of the annular electrode 41 is farther away from the fourth end portion E4 of the tubular member 2 than the spray opening K3, and the distance between the at least part of the tubular electrode 41 and the spray opening K3 is ranged from 11 mm to 30 mm.

That is, in the first direction and on the side of the spray opening K3 away from the second end portion E2 of the housing 3, at least part of the annular electrode 41 is located at a position from 11 mm to 30 mm from the spray opening.

Referring to FIGS. 3A to 5B, the tubular member 2 includes a tubular body part 20, and an annular pressing element 21 and a strip-shaped pressing element 22 which are connected to the tubular body part 20. The electrode assembly 4 is partially embedded and mounted in the tubular member 2 through the annular pressing element 21 and the strip-shaped pressing element 22.

The tubular body part 20 is provided with an annular groove T1 at the third end portion E3. In the second direction perpendicularly intersecting the first direction, a first portion 201 of the tubular body part 20 is located between the annular groove T1 and the second inner surface 29, and a second portion 202 of the tubular body part 20 is located between the annular groove T1 and the first outer surface 28.

The annular electrode 41 is at least partially located in the annular groove T1 of the tubular body part 20. The annular pressing element 21 is connected to the tubular body part 20 and is configured to limit the position of the annular electrode 41 in the first direction. The connection manner of the annular pressing element 21 and the tubular body part 20 is not limited herein.

For example, the second accommodating space S2 is in communication with the annular groove T1. In this way, it is beneficial to improve the charging efficiency of the annular electrode 41 for the mist.

For example, the annular pressing element 21 includes a first pressing element body part 210 in an annular shape. The first pressing element body part 210 is buckled to the second portion 202 of the tubular body part 20 by for example a buckle structure 211. The first pressing element body part 210 is spaced apart from the annular electrode 41 in the first direction.

For example, the annular pressing element 21 further includes a plurality of first protrusions 212; the plurality of first protrusions 212 are arranged at intervals on the surface of the first pressing element body part 210 facing towards the annular electrode 41 and abut against at least one selected from a group consisting of the first portion 201 of the tubular body part 20 and the annular electrode 41. It is understood that, the plurality of first protrusions 212 in the embodiment are used to maintain the distance between the first pressing element body part 210 and the annular electrode 41; however, the embodiments of the present disclosure are not limited thereto.

In another example, the connection between the first pressing element body part 210 and the tubular body part 20 and the connection between the annular electrode 41 and the tubular body part 20 are sufficient to maintain the distance between the first pressing element body part 210 and the annular electrode 41; in this situation, there is no need to provide the plurality of first protrusions 212 on the surface of the first pressing element body part 210 facing towards the annular electrode 41.

In the example shown in FIG. 5B, the first protrusion 212 abuts against both the first portion 201 of the tubular body part 20 and the annular electrode 41. In another example, the first protrusion 212 abuts against only one of the first portion 201 of the tubular body part 20 and the annular electrode 41.

For example, the surface of the first pressing element body part 210 facing towards the annular electrode 41 is an annular flat surface.

In the first direction, each of the plurality of first protrusions 212 has a thickness greater than 0 and less than or equal to 5 mm.

For example, referring to FIG. 5A, a strip-shaped groove T2 is provided on an inner side of the tubular body part 20. Herein, the inner side of the tubular body part 20 refers to the side of the tubular body part 20 facing towards the second accommodation space. The strip-shaped groove T2 and the strip-shaped pressing element 22 are matched with each other in shape. The strip-shaped pressing element 22 is at least partially located in the strip-shaped groove T2. The strip-shaped pressing element 22 limits a portion of the strip-shaped electrode 42 between the tubular body part 20 and the strip-shaped pressing element 22. Another portion of the strip-shaped electrode 42 is located outside the tubular member 2 at the side of the tubular member 2 away from the second opening K2.

For example, referring to FIG. 4B, an end of the another portion of the strip-shaped electrode 42 is provided with a wire pin 43, which is configured to be electrically connected to the electrostatic generation module.

Referring to FIGS. 3B and 4A, for example, the annular pressing element 21 further includes a second protrusion 213 on the surface of the first pressing element body part 210 facing towards the annular electrode 41.

The strip-shaped pressing element 22 includes a second pressing element body part 220 in a strip shape and at least one first fin 221 located on the second pressing element body part 220. In the assembling state shown in FIG. 5B, the second protrusion 213 presses against the at least one first fin 221 in the strip-shaped groove T2 and is located on a side of the at least one first fin 221 facing towards the second accommodating space S2.

For example, the strip-shaped pressing element 22 further includes at least one second fin 222, and the at least one second fin 222 is located at an end of the second pressing element body part 220 away from the at least one first fin 221, and the strip-shaped pressing element 22 is engaged into the strip-shaped groove T2 of the tubular member 2 through the at least one second fin 222.

Although the strip-shaped electrode 42 and the strip-shaped pressing element 22 both have a substantially linear shape in the above-mentioned embodiments, the embodiment of the present disclosure is not limited thereto. For example, in another example, the strip-shaped electrode 42 and the strip-shaped pressing element 22 for example have an arc shape.

For example, the electrostatic spray device provided by the embodiments of the present disclosure further includes a light emitting element 23 mounted at the fourth end portion E4 of the tubular member 2.

Referring to FIGS. 3A and 3B, the fourth end portion E4 of the tubular member 2 is provided with a plurality of mounting parts 24 protruding from the first outer surface 28 in the second direction. At least one mounting through hole extending in the first direction is formed in each mounting part 24. The light emitting element 23 is mounted on the mounting part 24 through the mounting through hole. In this way, the spray sprayed by the electrostatic spray device can be illuminated.

The light emitting element 23 includes for example a lamp that emits blue light. In another example, the light-emitting element 23 includes for example a lamp that emits light of other colors. In another example, the light-emitting element 23 can also include lamps with other functions.

With continued reference to FIG. 1, for example, the electrostatic spray device provided by the embodiment of the present disclosure further includes an electrostatic generating module 10 configured to provide a constant voltage to the annular electrode 41.

In the first direction, the electrostatic generating module 10 is located between the nozzle 5 and the airflow providing member 11.

In another embodiments, the strip-shaped electrode 42 and the strip-shaped pressing element 22 can be omitted. The annular electrode 41 can be electrically connected to the electrostatic generating module 10 through other known electrical connection structure. In addition, the connection manner of the annular electrode 41 and the housing 3 is not limited herein.

For example, the electrostatic spray device provided by the embodiments of the present disclosure further includes a liquid pump 9 and a first connecting pipe 7. In the first direction, the liquid pump 9 is located between the nozzle 5 and the airflow providing member 11, and the first connecting pipe 7 communicates the nozzle 5 with the liquid pump 9.

The electrostatic generation module 10 is connected to the electrode assembly 4, so that the annular electrode 41 has a high potential of the first polarity to generate an electric field. When the mist sprayed by the nozzle 5 passes through the region where the electric field is located, they are electrostatically induced and carries the electrostatic charges of the second polarity opposite to the first polarity. The mist with the electrostatic charge of the second polarity are ejected from the second opening K2 to exit the electrostatic spray device.

For example, the electrostatic spray device provided by the embodiments of the present disclosure further includes a second connecting pipe 8 and a liquid storage bottle 1.

The liquid storage bottle 1 needs to be filled with liquid frequently, so it is detachably connected to the housing 3 by adopting a buckle structure.

The liquid storage bottle 1 includes a bottle body 1-1 and a bottle cap 1-2, and at least one selected from a group consisting of the bottle body 1-1 and the bottle cap 1-2 is detachably connected to the housing 3. The second connecting pipe 8 fluidly communicates the liquid storage bottle 1 to the liquid pump 9.

For example, the bottle body 1-1 and the bottle cap 1-2 are connected to each other by a screw thread structure.

In the embodiment shown in FIG. 1, both the bottle body 1-1 and the bottle cap 1-2 are detachably connected to the housing 3. In another example, the bottle body 1-1 is detachably connected to the housing 3, while the bottle cap 1-2 is for example integrally formed with the housing 3.

In the electrostatic spray device provided by the embodiments of the present disclosure, the electrostatic generating module 10 is located between the liquid pump 9 and the airflow providing member 11 in the first direction.

At least two selected from a group consisting of the nozzle 5, the liquid pump 9, the electrostatic generation module 10, and the airflow providing member 11 are coaxially arranged.

For example, the airflow providing member 11 is an axial flow fan.

In the embodiment shown in FIG. 1, the nozzle 5, the liquid pump 9, the electrostatic generating module 10 and the airflow providing member 11 are coaxially arranged. Herein, two members which are coaxially arranged means that the central axes of the two members coincide with each other, and a certain positional deviation between the central axes of the two members is tolerated. The central axis of a certain member is a virtual straight line located at a central position of the member. For example, the central axis of a certain member is a symmetry axis of the member.

For example, the first end portion E1 of the housing 3 has a tubular shape.

For example, the nozzle 5, the tubular member 2, the first end portion E1 of the housing 3, and the airflow providing member 11 are coaxially arranged.

In this way, the airflow from the airflow providing member 11 can wrap the mist sprayed from the nozzle 5 more completely, thereby blowing them farther, and it is beneficial for the mist sucked back onto the tubular member 2 to be again blown to a target region.

The type of the airflow providing member 11 is not limited herein. In another embodiment, the airflow providing member 11 is a vortex fan.

For example, the electrostatic spray device provided by the embodiment of the present disclosure further includes a holding part 13 and a battery module 14 which are connected to the second end portion E2 of the housing 3.

The housing 3 and the battery module 14 are located at two opposite ends of the holding part 13. The holding part 13 is provided with a switching element 12, and the battery module 14 is configured to provide power supply for at least one selected from a group consisting of the liquid pump 9, the electrostatic generating module 10 and the airflow providing member 11 under the control of the switching element 12.

For example, the switch element 12 and the holding part 13 are suitable for comfortable hand operation and holding. The battery module 14 for example provides electrical energy for the entire electrostatic spray device.

For example, the switching element 12 is configured to control the turning on and off of the airflow providing member 11 and of the liquid pump 9.

For example, by program control, the liquid pump 9 is configured to start later than the airflow providing member 11 in response to a control signal of the switching element 12. For example, in the case that the switch element 12 is pressed, the airflow providing member 11 first starts and then the liquid pump 9 starts. However, the embodiment of the present disclosure is not limited thereto. In another example, the liquid pump 9 and the airflow providing member 11 are set to substantially simultaneously start in response to a control signal of the switching element 12.

During operation, the switch element 12 is pressed, so that the airflow providing member 11 and the liquid pump 9 start in sequence; the drug is absorbed from the liquid storage bottle 1 into the liquid pump 9 through the second connecting pipe 8, and then enters the nozzle 5 through the first connecting pipe 7, finally, the drug is atomized and sprayed out. During the atomization and spraying process, the electrode assembly 4 charge the mist sprayed by the nozzle 5 with charges in opposite polarity by electrostatic induction.

The electrostatic generation module 10 is controlled by the switching element 12, or is controlled independently. That is, the start-up and shut-down of the electrostatic generating module 10 is controlled by the switching element 12 or is controlled by other switching elements.

In this embodiment, in the air-conveying direction of the airflow providing member 11, the liquid pump 9 and the electrostatic generating module 10 are both located downstream of the airflow providing member 11 (that is, in the first direction, the liquid pump 9 and the electrostatic generating module 10 both located between the airflow providing member 11 and the second opening K2 of the tubular member 2). As a result, the airflow providing member 11 can heat dissipate the liquid pump 9 and the electrostatic generation module 10, and also prevents the mist from entering the interior and damaging electrical elements.

For example, the electrostatic spray device provided by the embodiments of the present disclosure further includes an annular mesh member 15 located between the first end portion E1 of the housing 3 and the guide member 6 in the second direction. The annular mesh member 15 is located on the side of the fourth end portion E4 of the tubular member 2 away from the third end portion E3 in the first direction.

The annular mesh member 15 is made by, for example, an insulation material. The specific material of the annular mesh member 15 is not limited herein. For example, in another example, the annular mesh member 15 is made by a non-insulation material.

The annular mesh member 15 can prevent foreign matters outside the electrostatic spray device from entering the portion of the first accommodation space close to the second end portion E2 through the first gas channel P1 and the second gas channel P2.

For example, the annular mesh member 15 is in contact with both the guide member 6 and the housing 3, thereby playing a role of positioning the guide member 6 in the first accommodation space S1.

In addition, the electrostatic spray device provided by the embodiments of the present disclosure has the advantages of being portable and compact.

Herein, some points needs to be explained:

(1) Drawings of the embodiments of the present disclosure only refer to structures related with the embodiments of the present disclosure, and other structures may refer to general design.

(2) For clarity, in the drawings used to describe embodiments of the present disclosure, the thickness of layers or regions is enlarged or reduced, i.e., these drawings are not drawn to actual scale.

(3) In case of no conflict, features in the same embodiment and different embodiments of the present disclosure may be combined with each other to obtain new embodiments.

The foregoing embodiments merely are exemplary embodiments of the present disclosure, and not intended to define the scope of the present disclosure, and the scope of the present disclosure is determined by the appended claims.

1. An electrostatic spray device, comprising:
a housing, defining a first accommodating space and having a first end portion and a second end portion opposite to each other, a first opening being provided at a position of the first end portion farthest away from the second end portion in a first direction from the second end portion to the first end portion;
a tubular member, defining a second accommodating space and having a third end portion that is away from the second end portion in the first direction and a fourth end portion that is close to the second end portion in the first direction, a second opening being provided at a position of the third end portion farthest away from the fourth end portion in the first direction, and the second opening being located on a side of the first opening away from the second end portion in the first direction;
a nozzle, at least partially located in the second accommodation space, the nozzle comprising a spray opening at a position farthest away from the second end portion in the first direction, the spray opening being located on a side of the second opening facing towards the fourth end portion in the first direction, the nozzle being configured to spray mist towards the second opening through the spray opening, and the mist leaving the electrostatic spray device from the second opening in a charged state; and
an airflow providing member, configured to provide an airflow which is ejected through the first opening and the second opening to leave the electrostatic spray device.

2. The electrostatic spray device according to claim 1, wherein at least part of the first inner surface of the first end portion facing towards the first accommodating space encloses a first region on a reference plane perpendicular to the first direction, and an area of the first region gradually decreases as the reference plane moves along the first direction.

3. The electrostatic spray device according to claim 1, wherein at least part of the first outer surface of the tubular member facing away from the second accommodating space encloses a second region on the reference plane, and an area of the second region gradually decreases as the reference plane moves along the first direction; and the at least part of the first outer surface comprises a surface portion not overlapped with the tubular member in a second direction perpendicularly intersecting the first direction.

4. The electrostatic spray device according to claim 1, further comprising a guide member connected to the nozzle, at least part of the guide member is on a side of the fourth end portion of the tubular member away from the third end portion and is located outside the second accommodating space.

5. The electrostatic spray device according to claim 4, wherein:
the tubular member is partially located in the first accommodating space, and the first inner surface of the first end portion and the first outer surface of the tubular member facing away from the second accommodating space define a first gas channel; the second inner surface of the tubular member facing towards the second accommodation space and a guide surface of at least one selected from a group consisting of the guide member and the nozzle facing towards at least one selected from a group consisting of the tubular member and the housing define a second gas channel,
the first gas channel and the second gas channel intercept a first annular region and a second annular region on the reference plane respectively, and a ratio of an area of the second annular region to an area of a first annular region is ranged from 0.2 to 5.

6. The electrostatic spray device according to claim 5, wherein the guide member has a second outer surface exposed to at least one selected from a group consisting of the first accommodating space and the second accommodating space; in the first direction, the airflow providing member is located on the side of the fourth end portion of the tubular member away from the third end portion, at least part of the nozzle is located on a side of the guide member away from the airflow providing member, the at least part of the nozzle has a third outer surface exposed to at least one selected from a group consisting of the first accommodating space and the second accommodating space, and the guide surface comprises the third outer surface and the second outer surface;
at least part of the second outer surface encloses a third region on the reference plane, at least part of the third outer surface encloses a fourth region on the reference plane, an area of at least one selected from a group consisting of the third region and the fourth region gradually decreases as the reference plane moves along the first direction.

7. The electrostatic spray device according to claim 1, wherein, in the first direction, the second opening of the tubular member is positionally adjustable relative to at least one selected from a group consisting of the first opening of the housing and the spray opening of the nozzle.

8. The electrostatic spray device according to claim 7, wherein the housing and the tubular member are slidably connected to each other.

9. The electrostatic spray device according to claim 1, wherein in the first direction, a distance between the second opening and the first opening is ranged from 5 mm to 120 mm.

10. The electrostatic spray device according to claim 1, further comprising an annular electrode connected to the third end portion of the tubular member, wherein in the first direction, at least part of the annular electrode is farther away from the fourth end portion of the tubular member than the spray opening, and a distance between the at least part of the annular electrode and the spray opening is ranged from 11 mm to 30 mm.

11. The electrostatic spray device according to claim 10, wherein the tubular member comprises a tubular body part and an annular pressing element, the annular electrode is at least partially located in an annular groove of the tubular body part, and the annular pressing element is connected to the tubular body part and is configured to limit a position of the annular electrode in the first direction.

12. The electrostatic spray device according to claim 11, wherein the second accommodation space is in communication with the annular groove.

13. The electrostatic spray device of claim 12, wherein the tubular body part comprises a first portion located between the annular groove and the second inner surface in a second direction perpendicularly intersecting the first direction and a second portion located between the annular groove and the first outer surface in the second direction; the annular pressing element comprises a first pressing element body part in an annular shape, the first pressing element body part is buckled to the second portion of the tubular body part, and the first pressing element body part is spaced apart from the annular electrode in the first direction.

14. The electrostatic spray device according to claim 13, wherein the annular pressing element further comprises a plurality of first protrusions, the plurality of first protrusions are arranged at intervals on a surface of the first pressing element body part facing towards the annular electrode and abut against at least one selected from a group consisting of the first portion of the tubular body part and the annular electrode, each of the plurality of first protrusions has a thickness greater than 0 and less than or equal to 5 mm in the first direction.

15. The electrostatic spray device according to claim 13, further comprising a strip-shaped electrode connected to the annular electrode, wherein the tubular member further comprises a strip-shaped pressing element connected to the tubular body part, a strip-shaped groove is provided on an inner side of the tubular body part, and the strip-shaped pressing element is at least partially located in the strip-shaped groove and limits a portion of the strip-shaped electrode between the tubular body part and the strip-shaped pressing element, another portion of the strip-shaped electrode is located on a side of the tubular member away from the second opening and is located outside the tubular member.

16. The electrostatic spray device according to claim 15, wherein the annular pressing element further comprises a second protrusion on a surface of the first pressing element body part facing towards the annular electrode, the strip-shaped pressing element comprises a strip-shaped second pressing element body part and at least one first fin located on the second pressing element body part; the second protrusion presses against the at least one first fin in the strip-shaped groove and is located on a side of the at least one first fin facing towards the second accommodating space.

17. The electrostatic spray device according to claim 16, wherein the strip-shaped pressing element further comprises at least one second fin, and the at least one second fin is located at an end of the second pressing element body part away from the at least one first fin, and the strip-shaped pressing element is engaged into the strip-shaped groove of the tubular member through the at least one second fin.

18. The electrostatic spray device according to claim 4, further comprising a liquid pump and a first connecting pipe, wherein the liquid pump is located between the nozzle and the airflow providing member in the first direction, and the first connecting pipe communicates the nozzle with the liquid pump.

19. The electrostatic spray device according to claim 18, further comprising a second connecting tube and a liquid storage bottle, wherein the liquid storage bottle comprises a bottle body and a bottle cap, and at least one selected from a group consisting of the bottle body and the bottle cap is detachable connected to the housing, and the second connecting pipe fluidly communicates the liquid storage bottle to the liquid pump.

20. The electrostatic spray device according to claim 18, wherein two opposite ends of the guide member are connected to the nozzle and the liquid pump, respectively.

21-25. (canceled)
